(19) United States
(12) Patent Application Publication
(10) Pub. No.: US 2010/0178418 A1
(43) Pub. Date: Jul. 15, 2010

(54) DEVICE FABRICATION METHOD FOR HIGH POWER DENSITY CAPACITORS

(76) Inventor: Enis Tuncer, Knoxville, TN (US)

Correspondence Address: ORNL-UTB-LUEDEKA, NEELY & GRAHAM, P.O. BOX 1871, KNOXVILLE, TN, 37901, US

(21) Appl. No.: 12/491,697

(22) Filed: Jun. 25, 2009

Related U.S. Application Data
(63) Continuation-in-part of application No. 12/351,121, filed on Jan. 9, 2009.

(51) Int. Cl. B05D 5/12

(52) U.S. Cl. 427/79

(57) ABSTRACT

A method for manufacturing a bundle of fibers for use as a capacitor is disclosed. First and second fibers all having an electrically conductive fiber core and an electrically insulating cladding are provided and arranged in a bundle. The first end of the first fibers are arranged to protrude from a first end of the bundle, and the second ends of the second fibers are arranged to protrude from a second end of the bundle creating a plurality of first and second spaces defined by the protruding first and second ends of the first and second fibers and the non-protruding first and second ends of the second and first fibers respectively. The first and second spaces are filled with an electrically insulating material. First and second electrodes are provided that contact the fiber cores of the first and second fibers respectively so that an electric capacitance is established between the fiber cores of the first fibers and the fiber cores of the second fibers.

### CROSS REFERENCE TO RELATED APPLICATION

This patent application claims priority from and is a Continuation-in-Part of U.S. patent application Ser. No. 12/351,121 filed Jan. 9, 2009, entitled: WELL DEFINED STRUCTURES FOR CAPACITOR APPLICATIONS. Patent application Ser. No. 12/351,121 is incorporated herein by reference in its entirety.

### GOVERNMENT RIGHTS

This invention was made with government support under Contract No. DE-AC05-00OR22725 awarded by the U.S. Department of Energy. The government has certain rights in the invention.

### BACKGROUND

A capacitor is a passive electrical component that can store energy in the electric field between a pair of conductors. Capacitors can be manufactured to serve many purposes, from a small plastic capacitor used in a calculator to an ultra capacitor that can power a vehicle. The type of internal dielectric, the structure of the conductors, and the device packaging may all strongly affect the characteristics of the capacitor and the applications in which they can be used. While some capacitors are better for high frequency uses, some may be better for high voltage applications. Accordingly, there is always a need for capacitors that are smaller and lighter while maintaining a high energy density (high capacitance and high operating voltage). The present invention helps satisfy this need.

### SUMMARY

A method of manufacturing a bundle of fibers for use as a capacitor is disclosed. The method includes providing a plurality of first fibers having first ends and second ends and a plurality of second fibers having first ends and second ends, all having an electrically conductive fiber core and an electrically insulating cladding. Next, the plurality of first fibers and the plurality of second fibers are arranged in a bundle having a first end and a second end. The first ends of the first fibers protrude from the first end of the bundle creating a plurality of first spaces defined by the protruding first ends of the first fibers and the non-protruding first ends of the second fibers, and the second ends of the second fibers protrude from the second end of the bundle creating a plurality of second spaces defined by the protruding second ends of the second fibers and the non-protruding second ends of the first fibers. Then, the first spaces and the second spaces are filled with an electrically insulating material.

In some applications, a method of manufacturing a capacitor includes manufacturing a bundle of fibers as discussed above as well as providing a first electrode contacting the fiber cores of the first fibers proximal the first ends of the first fibers and providing a second electrode contacting the fiber cores of the second fibers proximal the second ends of the second fibers. In such applications, an electric capacitance is established between the fiber cores of the first fibers and the fiber cores of the second fibers. In some embodiments, before providing the first and second electrodes, the method includes heating the bundle to a temperature sufficient to soften the electrically conductive fiber cores and the electrically insulating claddings and drawing the bundle along the longitudinal axis of the plurality of first and second fibers to decrease the diameters of the fiber cores and the thicknesses of the claddings.

In various embodiments, the plurality of first fibers and the plurality of second fibers have claddings with hexagonal cross-sections, and the first fibers and second fibers are arranged such that substantially each of the first fibers is disposed adjacent to and aligned with six second fibers in a plurality of hexagonal structures, each hexagonal structure having one first fiber surrounded by six second fibers. In some embodiments, the electrically insulating material filling the first and second spaces comprises a plurality of prisms having hexagonal cross-sections. Typically, the second fibers are not uniquely associated with a particular first fiber, but are disposed adjacent to a plurality of the first fibers.

In various applications, the electrically insulating cladding is a glass dielectric chosen from the group consisting of soda-lime glass, boron-silicate glass, potash-lead-silicate glass, polymeric material, and combinations thereof. In others, the first fiber cores comprise at least one material selected from the group consisting of a metal, a semiconducting glass, a conducting polymer, and a composite. In yet other embodiments, the fiber cores of the first fibers and the second fibers have diameters within a range from 0.1 to 100 microns, and the distance between each core of the drawn first fibers may be between 0.1 and 100 microns.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a view of a portion of a bundle of composite rods in accordance with the present invention;

FIG. 2 is a view of the portion of the bundle of composite rods shown in FIG. 1 after heating, drawing, and re-bundling the composite rods in accordance with the present invention;

FIG. 3 is a view of the composite rods of the capacitor midsection in accordance with the present invention;

FIG. 4 is a cross-sectional view of a representative portion of the capacitor midsection shown in FIG. 3 in accordance with the present invention;

FIG. 5 is a cross-sectional view of a representative hexagon structure of FIG. 4 in accordance with the present invention;

FIG. 6 is a cross sectional view of a representative portion of the top cap, the capacitor midsection shown in FIG. 3, and the bottom cap of in accordance with the present invention;

FIG. 7 is a view of the fused top cap, capacitor midsection, and bottom cap having protruding first and second set of fiber cores before the electrodes are applied;

FIG. 8 is a view of the fused top cap, capacitor midsection, and bottom cap of shown in FIG. 7 having the first and second electrodes applied and disposed in a housing;

FIG. 9 is a flow diagram of a method of fabricating a capacitor according to the present invention;

FIG. 10 is a view of a representative portion of a top portion of a capacitor in accordance with the present invention;

FIG. 11 is a chart of the influence of dielectric permittivity on the thickness of cylindrical capacitors as compared to parallel plate capacitors;

FIG. 12 is chart of the influence of dielectric thickness on the capacitance of cylindrical capacitors as compared to parallel plate capacitors; and

FIG. 13 is a chart of the influence of dielectric thickness on the electric field of cylindrical capacitors as compared to parallel plate capacitors.

FIG. 14 is a view of a bundle of first and second fibers, the first fibers protruding from the bundle at a first end and the second fibers protruding from the bundle at a second end, creating spaces between the fibers.

FIG. 15 is a view of a row of fibers of the bundle of FIG. 14 where pieces of electrically insulating material are filling spaces between the first and second fibers.

FIG. 16 is a view of the bundle of FIG. 14 where the spaces are filled with the electrically insulating material.

### DETAILED DESCRIPTION

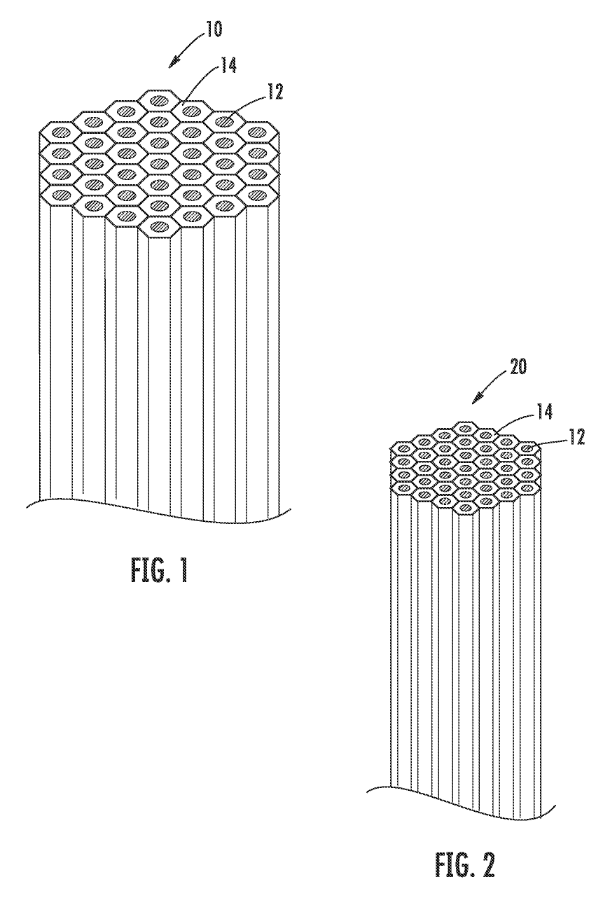

Referring to FIG. 1, composite fibers having an inner core 12 of a different material than the outer core 14 are arranged in an aligned array or matrix fiber bundle 10. The inner core 12 of each fiber is an electrically conductive fiber core while the outer core 14 is an electrically insulating cladding. The electrically conductive fiber core 12 preferably has a circular cross-section. The electrically insulating cladding 14 preferably has a hexagonal cross-sectional shape to minimize voids and give the structure the highest packing density when the fibers are arranged in the fiber bundle 10. However, the electrically insulating cladding 14 may also have a circular cross-section or other outer cross-sectional shape. In this case, the voids may be filled during subsequent processing.

The electrically conductive fiber core 12 may be a metal, semiconductor, or high permittivity non-linear dielectric materials. Common examples include stainless steel, copper, aluminum, or nickel wires; solder alloys; metal fiber, silicon carbide or carbon filled glass composites; and semi-conducting glasses. Carbon or metal powder filled conducting polymers are also suitable for use in cores. Examples of non-linear dielectric materials that may be used are barium titanate, lead titanate, calcium copper titanate, strontium titanate and composites of the aforementioned non-linear dielectric materials. Furthermore, in some embodiments the fiber bundle 10 may be groups of fiber cores 12 having differing compositions. For example, one group of fiber cores 12 within the fiber bundle 10 may be stainless steel while another group of fiber cores 12 may be a semi-conducting glass. The electrically insulating cladding 14 is preferably a dielectric glass such as soda-lime glass, boron-silicate glass, and potash-lead-silicate glass or high performance polymers. One reason a glass dielectric is preferable is that the capacitor would be thermally stable and can be used at elevated temperatures.

The fiber bundle 10 may be shaped and sized by a process called melt pulling. During melt pulling, the fiber bundle 10 of FIG. 1 is heated to a temperature sufficient to soften the materials of the fiber bundle 10. The bundle 10 is then drawn along the longitudinal axis of the fibers to reduce the diameter of the fiber core 12 and cladding 14. The fibers are fused and re-bundled into a smaller diameter fiber bundle 20 as shown in FIG. 2. The smaller diameter bundle 20 may be cut transversely into sections which can be fused together into a larger bundle to increase the number of fibers and respective electrically conductive fiber cores 12. This sequence of drawing, bundling, cutting, and fusing may be repeated as necessary in order to obtain a larger diameter bundle having electrically conductive fiber cores 12 of a desired diameter and spacing. Using the melt pulling process, electrically conductive fiber core 12 diameters and spacing on the nanometer scale is possible. Furthermore, adjustment of the diameters of the fiber cores 12 and cladding 14, height of the bundle, and/or number of fiber cores 12 contained therein can be easily varied during the process as desired.

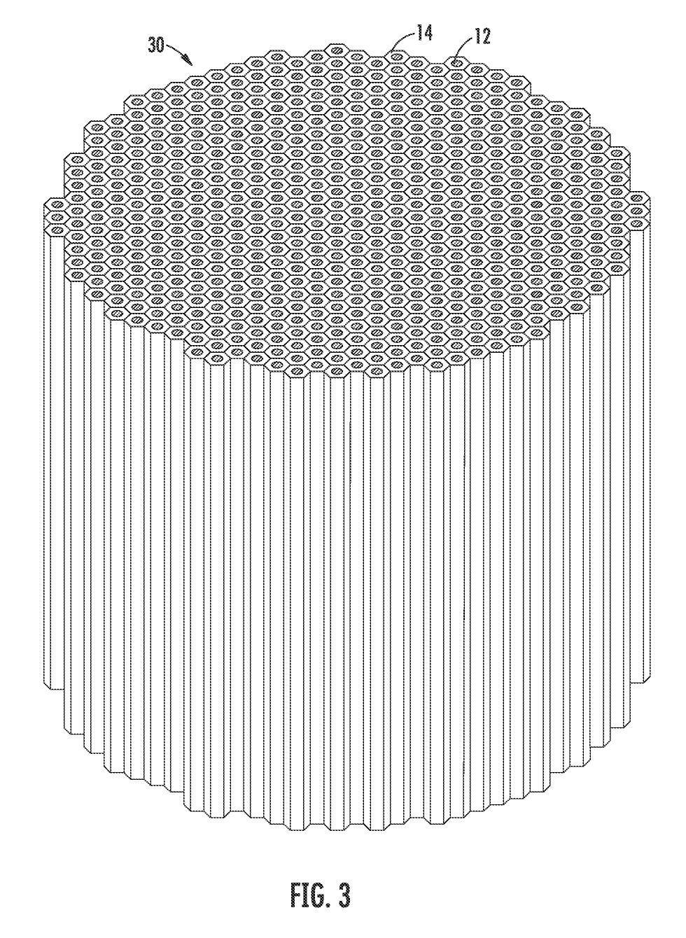

After the final draw (which could be the first draw) the larger diameter bundle may be cut in order to obtain a final bundle as shown in FIG. 3 that becomes a capacitor midsection 30. Although a cylindrical capacitor midsection 30 is shown, a capacitor midsection 30 of any desired shape and configuration can be formed and used in making various capacitor embodiments.

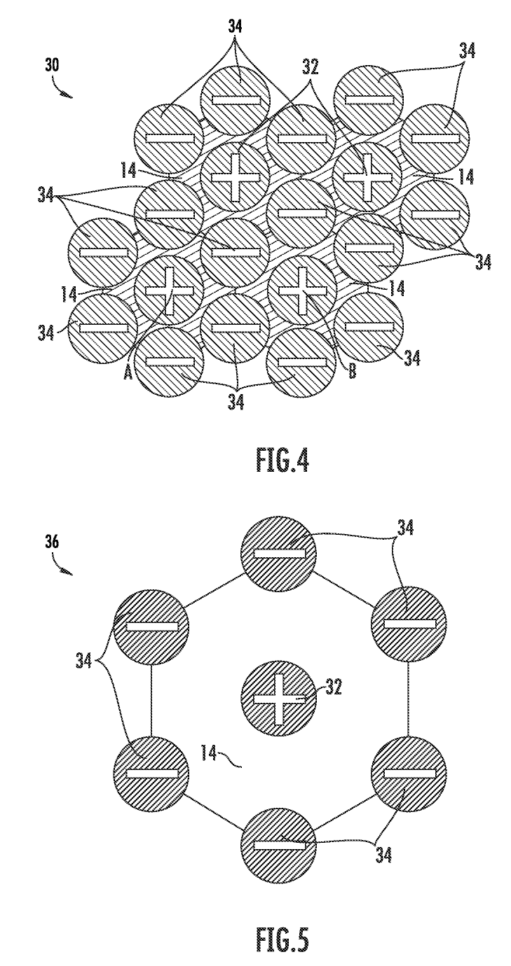

In turning the capacitor midsection 30 into a capacitor, structured electrodes are needed to access the individual electrically conductive fiber cores 12. Referring to FIG. 4, a cross sectional view is shown of the fibers of a representative portion of the capacitor midsection 30. In a preferred embodiment, the electrically conductive fiber cores 12 of the capacitor midsection 30 are divided into a first set 32 of spaced apart drawn conductive fiber cores (shown in FIGS. 4, 5, and 6 with a plus sign) and a second set 34 of spaced apart drawn conductive fiber cores (shown in FIGS. 4, 5, and 6 with a negative sign). The electrically insulating cladding 14 provides the spacing between the first set 32 and second set 34 of fiber cores. As shown in FIG. 6, the capacitor midsection 30 becomes a capacitor when a first electrode 33 is provided to contact the first set 32 of fiber cores and a second electrode 35 is provided to contact the second set 34. An electric capacitance is established between the first set 32 and second set 34 of spaced apart drawn conductive fiber cores when a potential is applied across the first electrode 33 and second electrode 35.

In a preferred embodiment and as shown in FIG. 4, the first set 32 of spaced apart drawn conductive fiber cores is disposed adjacent to and aligned with six fiber cores of the second set 34 to make a plurality of hexagon structures 36. However, the first set 32 of fiber cores may be disposed adjacent to and aligned with any number of fiber cores of the second set 34. Regardless of the number of fiber cores of the second set 34 that are disposed adjacent to and aligned with the fiber cores of the first set 32, each fiber core of the first set 32 may share fiber cores of the second set 34 with other fiber cores of the first set 32. Preferably, at least two fiber cores of the second set 34 are positioned between two fiber cores of the first set 32 (which are shown as cores A and B). In other words, each of cores A and B is surrounded by six fiber cores of the second set 34, but two of the cores surrounding A are also in the group of six cores surrounding B.

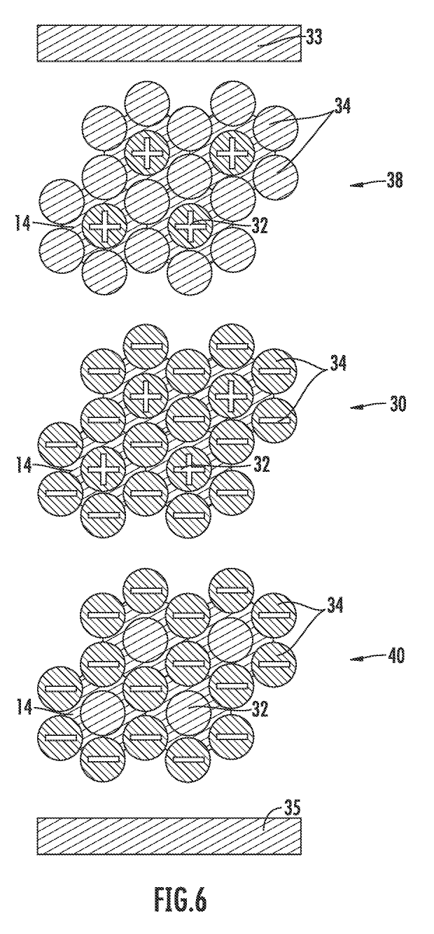

Referring to FIG. 5, a representative hexagon structure 36 of the preferred embodiment is shown. Each hexagon structure 36 in the capacitor midsection 30 resembles a cylindrical capacitor with the smallest unit a hexagon having a fiber core of the first set 32 having a different potential than the outer fiber cores of the second set 34. The capacitance for cylindrical structures is as follows:

$${C}_{cyl} = 2 {πɛɛ}_{0} \frac{height}{ln ( outer / inner )}$$

In preferred embodiments, the first and second fiber cores have a diameter ranging from 0.1 to 100 microns while the distance between each fiber core of the first set is between 0.1 and 100 microns. In a typical embodiment, all fiber cores have substantially the same diameter, and that diameter falls within the aforementioned range. However, other embodiments may have cores with different diameters, for example, in the range of 0.01 to 0.1 microns.

To illustrate the electrical field distribution for the hexagon structure 36 of FIG. 5, numerical calculations can be performed on one fiber of the second set 34 of hexagon 36 having side ‘a’, height ‘a’, and an electrically conductive fiber core 12 diameter of ‘0.6a’. Thus, using the formula for the capacitance for cylindrical structures, the capacitance of the fiber core presented is approximately 1 pF. Because each hexagon structure 36 has six fiber cores of the second set 34, each hexagon structure 36 will have a capacitance of 6 pF. Assuming that the size of the hexagon is 10 microns, 2×10⁵ hexagons can be packed into a 1 sq-cm capacitor midsection 30. If the height of the capacitor midsection 30 is 1 cm, then the total capacitance is approximately 1 microfarad (6 pF×2×10⁵×1 cm/10 μm). However, if the structure is made ten times smaller, the capacitance then becomes 1000 times higher.

Thus, the process of melt pulling may increase the number density of the hexagon structures 36 within the capacitor midsection 30. By increasing the number density of these structures 36, high capacitance capacitors can be obtained. In preferred embodiments, the capacitor midsection 30 generally includes a number of hexagon structures 36 ranging from 10⁵ structures per sq-cm to 10¹¹ structures per sq-cm. The capacitance of the system can be also be adjusted by varying the inner diameter of the first set 32 and second set 34 of drawn conductive fiber cores, the height or diameter of the capacitor midsection 30, and the permittivity and thickness of the electrically insulating cladding 14. The varying of these dimensions can all be effectively accomplished during the melt pulling process described above.

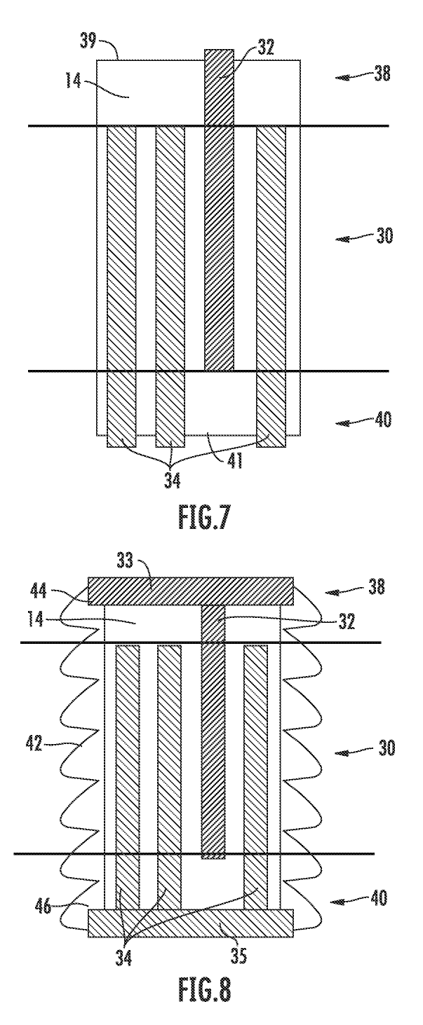

The particular method of applying the first electrode 33 and second electrode 35 to contact the electrically conductive fiber cores 12 and utilize capacitor midsections 30 of numerous configurations may vary. The method used oftentimes will depend on the size of the midsection 30 and the size of the fibers. Referring to FIG. 6, in one embodiment the first set 32 and second set 34 of fiber cores of the capacitor midsection 30 are accessed by the first electrode 33 and second electrode 35 using top and bottom caps 38 and 40. FIG. 6 shows cross sectional views of the fibers of a representative portion of the capacitor midsection 30, top cap 38, and bottom cap 40. Using the melt pulling method described above, the top and bottom cap 38 and 40 may be fabricated separately using the same technique as used in making the capacitor midsection 30. The surface of top cap 38 may then be contacted with an etchant/solvent that removes more of the insulating cladding 14 and second set 34 of fiber cores than the first set 32 of fiber cores to create an array of protruding first set 32 of spaced apart drawn conductive fiber cores. The surface of bottom cap 40 is also contacted with an etchant/solvent that removes more of the insulating cladding 14 and first set 32 of fiber cores than the second set 34 of fiber cores to create an array of protruding second set 34 of spaced apart drawn conductive fiber cores. Referring to FIG. 7, fiber alignment technology may then be used to align and fuse the top cap 38 and bottom cap 40 to the capacitor midsection 30 so that the first set 32 of fiber cores protrudes from the top surface 39 of the fused embodiment and the second set 34 of fiber cores protrudes from the bottom surface 41.

As shown in FIG. 8, the fused top cap 38, bottom cap 40, and capacitor midsection 30 may then be disposed within a housing 42 having a proximal 44 and distal end 46. The capacitor midsection 30 functions as a capacitor when a first electrode 33 is disposed at the proximal end 44 of the housing 42 and contacts the first set 32 of fiber cores protruding from the top cap 38, and a second electrode 35 is disposed at the distal end 46 of the housing 42 and contacts the second set 34 of fiber cores protruding from the bottom cap 40. An electric field is established between the first set 32 and second set 34 of spaced apart drawn conductive fiber cores of the capacitor midsection 30 when a potential is applied across the first electrode 33 and the second electrode 35.

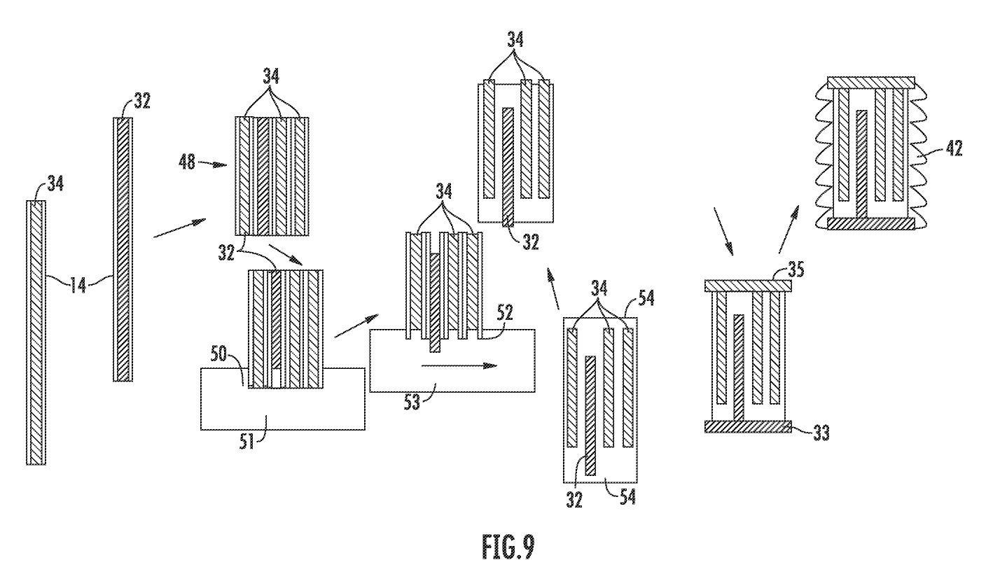

Referring to FIG. 9, a similar method of applying the electrodes is shown except top and bottom caps do not need to be fabricated. In the method of FIG. 9, a plurality of fibers are drawn and fused as described above into a bundle 48. The fiber cores of the first set 32 and the fiber cores of the second set 34 are made of different materials so they will have different etch rates. A first surface 50 of the bundle 48 is contacted with a first etchant 51 that removes more of the first set 32 of fiber cores than the second set 34 of fiber cores to create an array of protruding second set 34 of spaced apart drawn conductive fiber cores. The second surface 52 is then contacted with a second etchant 53 that removes more of the second set 34 of fiber cores than the first set 32 of fiber cores to create an array of protruding first set 34 of spaced apart drawn conductive fiber cores. Coating terminations 54 may be applied to the first surface 50 and second surface 52 of the capacitor midsection 30. The coating terminations 54 may be any type of insulation such as the materials of the electrically insulating cladding 14 or any resin based material. The coating terminations 54 are then polished and etched to reveal the protruding fiber cores 32 and 34 before the first electrode 33 and second electrode 35 are applied.

In alternate embodiments, the composite fibers may be prefabricated so that they protrude from the top and bottom surface of the capacitor midsection 30 after they are bundled and fused together. In that case, no etching and coating of the terminations would be needed.

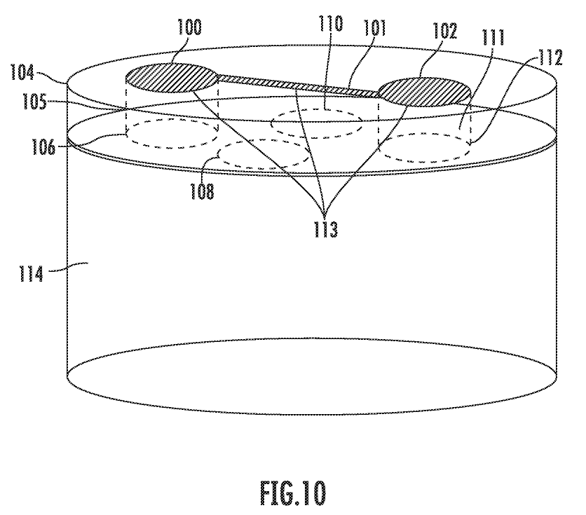

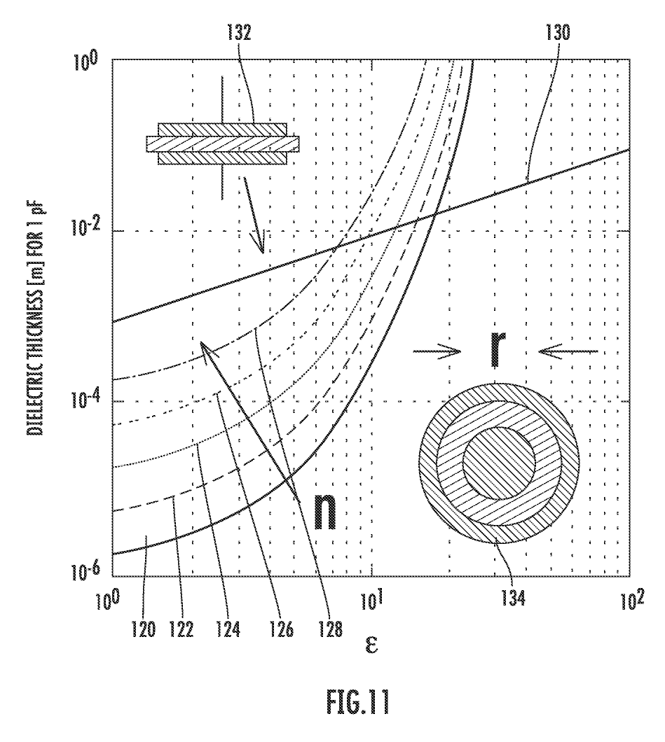

In another embodiment, the capacitor midsection 30 has a plurality of composite fibers with cores and cladding as discussed previously, but in FIG. 10 the fiber cores 106, 108, 110 and 112 have been greatly enlarged for illustration purposes and the number of fibers shown is drastically reduced. In FIG. 10, an insulating cap 104 has been deposited on the end of the capacitor midsection 30. The ends of two fiber cores 108 and 110 are terminated in the insulation, and these two cores 108 and 110 represent the second set of cores 34. The ends of two cores 106 and 112 represent the fiber cores of the first set of cores 32 and are in electrical contact with two bores 105 and 111 that are filled with a conductor. The two bores 106 and 112 are holes, but this does not mean that the bores were necessarily drilled or that the bores have a circular cross section. The bores 106 and 112 terminate at their upper end at conductive disks 100 and 102 that are connected by a conductive trace 101. The disks 100 and 102 and the trace 101 are collectively an electrode 113 that electrically contacts all of the cores 106 and 112 of the first set 32.

The insulating cap 104 is formed on the capacitor midsection 30 at the completion of the drawing process by techniques appropriate for the size of the bundle. In applications where the capacitor midsection 30 is relatively large, having a diameter of one or more centimeters, for example, the bores may be formed by micro-drilling through the insulating cap 104. In applications where the capacitor midsection 30 is relatively small, having a diameter of about 300 microns or less, for example, the bores 105 and 111 may be formed using photo-resist masking and etching techniques that are used in the manufacture of electronic integrated circuits and micro printed circuits. Regardless of the technique for forming the bores 105, the location of the bores may be established by photographing the end of the fiber bundle prior to applying the insulating cap 104 so that the exact location of each core 106, 108, 110 and 112 is known precisely.

Once the bores 105 and 111 are formed, the electrical connection is formed by filling the bores with a conductive material using a technique that is again appropriate for the application and the size of the capacitor midsection 30. The conductive trace 101 is formed between the bores 105 and 111 so that the conductive material in the bores and the conductive trace 101 form a single electrode 113. Metal filling techniques and metal deposit techniques used in the electronics industry are appropriate for filling the bores 105 and 111 and forming the trace 101.

The fiber cores 108 and 110 represent the fiber cores of the second set 34, and these cores are insulated from the cores 106 and 112 of the first set 32. The cores 108 and 110 are joined together electrically to contact an electrode in a construction that is substantially the same as described above. Preferably, the cores 108 and 110 are connected together at the opposite end of the capacitor midsection 30 from the end shown in FIG. 8. However, in some applications it may be desirable to make all of the electrical connections at one end of the capacitor midsection 30. In such case, a bore would be formed in the cap 104 to communicate with all of the cores 106, 108, 110 and 112. Then two separate traces would be formed on the cap so that the cores of the first set 32 would be connected together, the cores of the second set 34 would be connected together, and no core of the first set 32 would be electrically connected to any core of the second set 34.

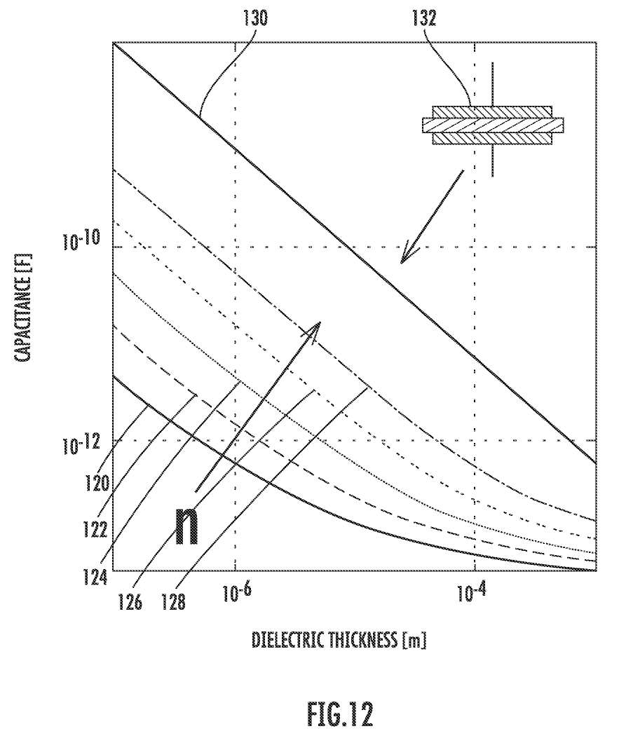

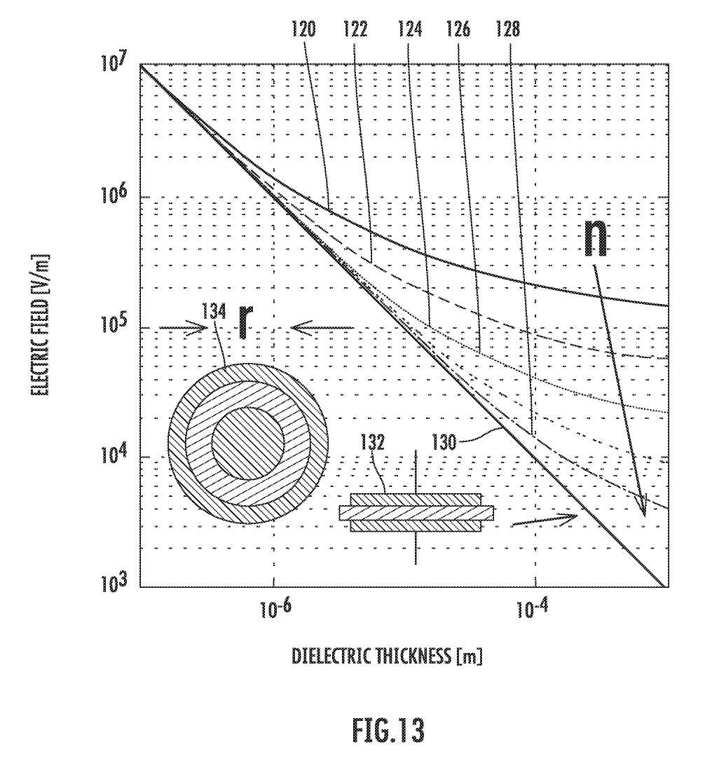

FIGS. 11-13 represent advantages of the present invention over parallel plate capacitors. The capacitances Cₚₚ for parallel plate and C_{cyl} for cylindrical structures are given as follows:

$${C}_{pp} = {ɛ}_{0} ɛ \frac{area}{thickness}$$

$${C}_{cyl} = 2 {πɛɛ}_{0} \frac{height}{ln ( outer / inner )}$$

In FIGS. 9-11, the size of the parallel plate was assumed to be 1 sq-cm while the height of the capacitor midsection 30 was assumed to be 1 cm. The curved lines for increasing “n” were drawn representing various diameters of the electrically conducting fiber cores 12 where r=10ⁿ micron and n={0, 0.5, 1.0, 1.5, 2}. The straight line in the figures represents the parallel plate capacitor.

Referring to FIG. 9, the influence of dielectric permittivity (the insulating cladding 14 of the present invention) on the thickness a capacitor having a capacitance of 1 pF is shown. As exhibited by the curved lines (referencing a cylindrical capacitor of various diameter fiber cores 12) intersecting the straight line of the parallel plate capacitor, there is a cross-over permittivity where the dielectric thickness needed for the cylindrical capacitor exceeds that of a parallel plate capacitor. However, for dielectrics having a relative permittivity of less than 10, the dielectric thickness needed to have 1 pF capacitance is less for a cylindrical capacitor than for a parallel plate capacitor.

FIG. 10 shows the capacitances for cylindrical capacitors for various dielectric thicknesses where the curved lines again represent cylindrical capacitors of different diameter fiber cores 12 and the straight line represents that of a parallel plate capacitor. For small dielectric thickness the cylindrical arrangement acts like the parallel plate capacitor, however, the present invention has the advantage of packing many fiber cores to a small volume.

Referring to FIG. 11, the electric field is shown for various dielectric thicknesses. For large diameter fiber cores 12 and thin dielectric thicknesses, the cylindrical capacitor and the parallel plate capacitor have similar electric field distributions. However, for smaller diameter fiber cores 12, the electric field is greater.

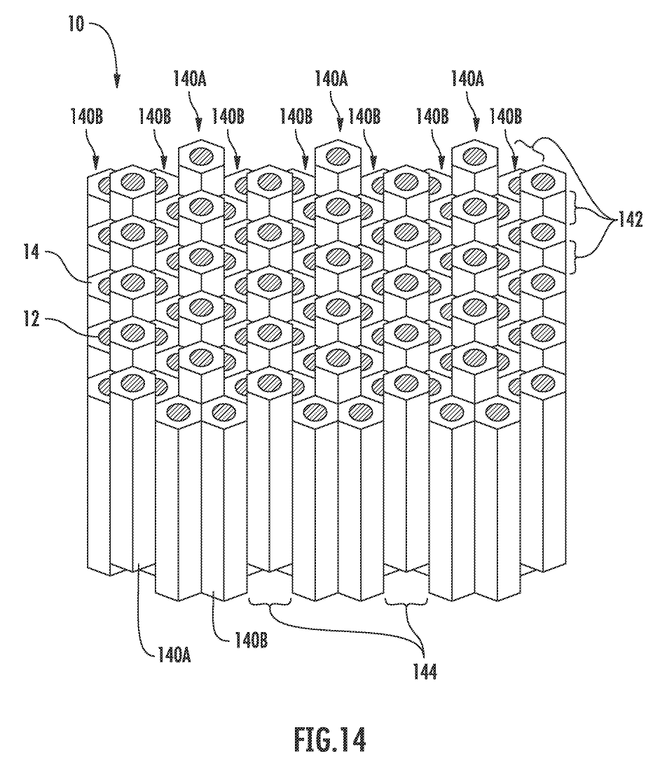

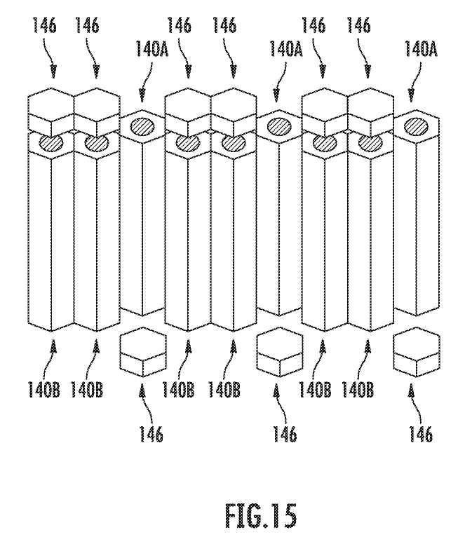

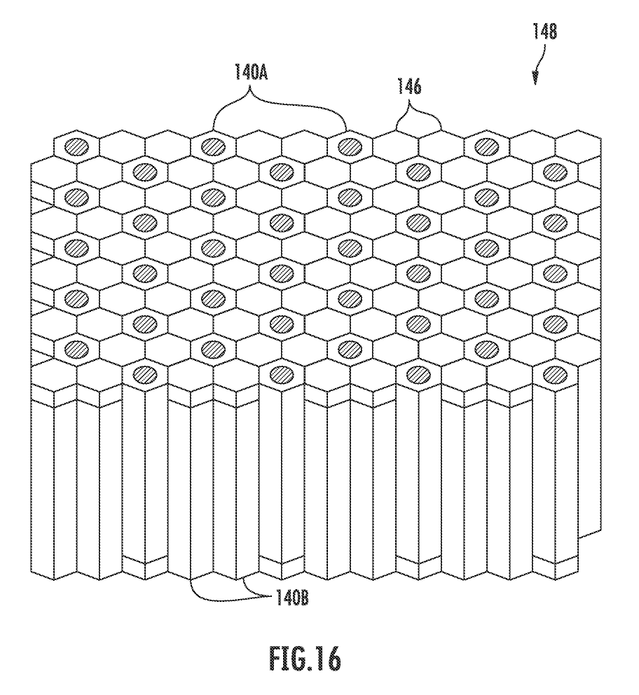

Referring to FIGS. 14-16, an alternate embodiment of the invention includes a bundle of fibers 10 having a plurality of first fibers 140A and a plurality of second fibers 140B. As discussed above, each of the fibers has an electrically conductive fiber core 12 and an electrically insulating cladding 14. The first fibers 140A are arranged so that first ends of the first fibers protrude from a first end of the bundle 10. A plurality of first spaces 142 are defined by the protruding first ends of the first fibers 140A and the non-protruding first ends of the second fibers 140B. Similarly, a plurality of second spaces 144 are defined by the protruding second ends of the second fibers 140B and the non-protruding second ends of the first fibers 140A. Both the first and second spaces 142 and 144 are filled with an electrically insulating material 146 as shown in FIG. 15. The electrically insulating material, in most applications, is the same material as the electrically insulating cladding 14. The resulting bundle 148 is shown in FIG. 16. The bundle 148 may be drawn to decrease the diameter of the bundle and increase the length of the bundle to produce an elongate, small diameter capacitor. Typically, before drawing, the bundle will be heated to a temperature sufficient to soften the materials of the bundle to a softness appropriate for the drawing process.

In some applications of the embodiment of FIGS. 14-16, the fibers are arranged such that individual first fibers 140A are disposed adjacent to and aligned with six second fibers 140B. Typically, the first and second fibers 140A and 140B are arranged in a plurality of hexagonal structures forming a hexagonal lattice with each hexagonal structure including one first fiber 140A surrounded by six second fibers 140B as shown in FIGS. 14 and 16. Most or all of the second fibers 140B are part of three adjacent and overlapping hexagonal structures formed with a first fiber 140A at each of their centers as shown in FIG. 16. In these embodiments, the first fibers 140A and second fibers 140B are generally not unique in composition and structure to one another, but rather, the distinction between first and second fibers 140A and 140B merely indicates their relative position with respect to the bundle of fibers 10.

The first fibers 140A typically are pushed to protrude from the first end of the bundle 10 in the desired configuration by a mechanical device. For example, a negative mold having holes in the positions of every first fiber 140A causes the first fibers 140A to shift vertically when the bundle is positioned on the mold. Likewise, a negative mold having holes in the positions of every second fiber 140B can be used.

The bundle 10 of FIGS. 14-16 works as a capacitor in a similar fashion as the previously described embodiments of the invention. As before, a first electrode is connected to the first ends of the first fibers 140A, and a second electrode is connected to the second ends of the second fibers 140B creating an electric capacitance between the fibers when activated.

Typically, the materials used in these embodiments are considered high temperature materials, and therefore allow fabrication of capacitor devices that can be used in high temperature and high power density applications, such as in power electronics and the defense industry.

The foregoing description of preferred embodiments for this invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as dined by the appended claims when interpreted in accordance with the breadth to which they are fairly, legally, and equitably entitled.

What is claimed is:

1. A method of manufacturing a bundle of fibers for use as a capacitor comprising:
providing a plurality of first fibers, each of the first fibers having a first end and a second end, an electrically conductive fiber core, and an electrically insulating cladding;
providing a plurality of second fibers, each of the second fibers having a first end and a second end, an electrically conductive fiber core, and an electrically insulating cladding;
arranging the plurality of first fibers and the plurality of second fibers into a bundle having a first end and a second end, wherein:
the first ends of the first fibers protrude from the first end of the bundle creating a plurality of first spaces defined by the protruding first ends of the first fibers and the non-protruding first ends of the second fibers, and
the second ends of the second fibers protrude from the second end of the bundle creating a plurality of second spaces defined by the protruding second ends of the second fibers and the non-protruding second ends of the first fibers; and
filling the first spaces and the second spaces with an electrically insulating material.

2. The method of claim 1 wherein the plurality of first fibers and the plurality of second fibers are arranged such that substantially each of the first fibers is disposed adjacent to and aligned with six second fibers.

3. The method of claim 2 wherein at least one of the six second fibers is disposed adjacent to a plurality of the first fibers.

4. The method of claim 1 wherein the plurality of first fibers and the plurality of second fibers are arranged in a plurality of hexagonal structures, each of the hexagonal structures having one of the first fibers surrounded by six of the second fibers.

5. The method of claim 1 wherein the electrically insulating cladding comprises a glass dielectric selected from the group consisting of soda-lime glass, boron-silicate glass, potash-lead-silicate glass, polymeric material, and combinations thereof.

6. The method of claim 1 wherein the first fiber cores comprise at least one material selected from the group consisting of a metal, a semiconducting glass, a conducting polymer, and a composite.

7. The method of claim 1 wherein the claddings of the first and second fibers have hexagonal cross-sections.

8. The method of claim 1 wherein the electrically insulating material filling the first and second spaces comprises a plurality of prisms having hexagonal cross-sections.

9. The method of claim 1 further comprising:
heating the bundle to a temperature sufficient to soften the electrically conductive fiber cores and the electrically insulating claddings; and
drawing the bundle along the longitudinal axis of the plurality of first and second fibers to decrease the diameters of the fiber cores and the thicknesses of the claddings.

10. A method of manufacturing a capacitor comprising:
manufacturing a bundle of fibers including:
providing a plurality of first fibers, each of the first fibers having a first end and a second end, an electrically conductive fiber core, and an electrically insulating cladding;
providing a plurality of second fibers, each of the second fibers having a first end and a second end, an electrically conductive fiber core, and an electrically insulating cladding;
arranging the plurality of first fibers and the plurality of second fibers into a bundle having a first end and a second end, wherein:
the first ends of the first fibers protrude from the first end of the bundle creating a plurality of first spaces defined by the protruding first ends of the first fibers and the non-protruding first ends of the second fibers, and
the second ends of the second fibers protrude from the second end of the bundle creating a plurality of second spaces defined by the protruding second ends of the second fibers and the non-protruding second ends of the first fibers; and
heating the bundle to a temperature sufficient to soften the electrically conductive fiber cores and the electrically insulating claddings;
drawing the bundle along the longitudinal axis of the plurality of first and second fibers to decrease the diameters of the fiber cores and the thicknesses of the claddings;
filling the first spaces and the second spaces with an electrically insulating material;
providing a first electrode contacting the fiber cores of the first fibers proximal the first ends of the first fibers; and
providing a second electrode contacting the fiber cores of the second fibers proximal the second ends of the second fibers,
wherein an electric capacitance is established between the fiber cores of the first fibers and the fiber cores of the second fibers.

11. The method of claim 10 wherein the plurality of first fibers and the plurality of second fibers are arranged such that substantially each of the first fibers is disposed adjacent to and aligned with six second fibers.

12. The method of claim 11 wherein at least one of the six second fibers is disposed adjacent to a plurality of the first fibers.

13. The method of claim 10 wherein the plurality of first fibers and the plurality of second fibers are arranged in a plurality of hexagonal structures, each of the hexagonal structures having one of the first fibers surrounded by six of the second fibers.

14. The method of claim 10 wherein each of the fiber cores of the first fibers and each of the fiber cores of the second fibers have diameters within a range from about 0.1 to 100 microns.

15. The method of claim 10 wherein the electrically insulating cladding comprises a glass dielectric selected from the group consisting of soda-lime glass, boron-silicate glass, potash-lead-silicate glass, polymeric material, and combinations thereof.

16. The method of claim 10 wherein the first fiber cores comprise at least one material selected from the group consisting of a metal, a semiconducting glass, a conducting polymer, and a composite.

17. The method of claim 10 wherein the distance between the fiber cores of the drawn first fibers is between about 0.1 and 100 microns.

18. The method of claim 10 wherein the claddings of the first fibers and the claddings of the second fibers have hexagonal cross-sections.

19. The method of claim 10 wherein:
the electrically insulating material filling the first spaces comprises a plurality of prisms having hexagonal cross-sections; and
the electrically insulating material filling the second spaces comprises a plurality of prisms having hexagonal cross-sections.

20. A method of manufacturing a capacitor comprising:
providing a plurality of first fibers, each of the first fibers having a first end and a second end, an electrically conductive fiber core, and an electrically insulating cladding;
providing a plurality of second fibers, each of the second fibers having a first end and a second end, an electrically conductive fiber core, and an electrically insulating cladding;
arranging the plurality of first fibers and the plurality of second fibers into a bundle having a first end and a second end, wherein:
the first ends of the first fibers protrude from the first end of the bundle creating a plurality of first spaces defined by the protruding first ends of the first fibers and the non-protruding first ends of the second fibers, and
the second ends of the second fibers protrude from the second end of the bundle creating a plurality of second spaces defined by the protruding second ends of the second fibers and the non-protruding second ends of the first fibers; and
filling the first spaces and the second spaces with an electrically insulating material; and
providing a first electrode contacting the fiber cores of the first fibers proximal the first ends of the first fibers; and
providing a second electrode contacting the fiber cores of the second fibers proximal the second ends of the second fibers,
wherein an electric capacitance is established between the fiber cores of the first fibers and the fiber cores of the second fibers.

21. The method of claim 20 wherein:
the claddings of the plurality of first fibers have substantially hexagonal cross-sections;
the claddings of the plurality of the second fibers have substantially hexagonal cross-sections;
the first fibers and second fibers are arranged such that substantially each of the first fibers is disposed adjacent to and aligned with six second fibers in a plurality of hexagonal structures, each hexagonal structure having one first fiber surrounded by six second fibers;
the electrically insulating material filling the first spaces comprises a plurality of prisms having hexagonal cross-sections; and
the electrically insulating material filling the second spaces comprises a plurality of prisms having hexagonal cross-sections.
